(19) United States
(12) Patent Application Publication
(10) Pub. No.: US 2006/0150071 A1
(43) Pub. Date: Jul. 6, 2006

(54) Software-based video rendering

(75) Inventor: Bi Chen, San Jose, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/029,860

(22) Filed: Jan. 5, 2005

(51) Int. Cl. G06F 17/00

(52) U.S. Cl. 715/500.1

(57) ABSTRACT

Systems and methods for software-based video rendering are described. A particular implementation includes computer readable media configured to monitor a display cycle of hardware components configured to scan video frames for display on a display device and to render a video frame based, at least in part, on the monitored display cycle.

### TECHNICAL FIELD

The invention pertains to video rendering and in particular to software-based video rendering.

### BACKGROUND

A large consumer demand exists for viewing media content. Media content can range from broadcast media, such as TV shows and box office movies, to home-made movies to video clips from the internet. Broadcast media is controlled by various standards bodies and adheres to certain standards such as video format and frame playback rate. Display devices configured to generate user-perceptible images from broadcast media adhere to similar standards. For example, TVs are configured to display each frame of video content for a specific period of time where the specific period of time is established by the standards body.

On the other hand, video media from the internet adheres to a loose set of standards at best. Video media from the internet can be in different formats, and configured for different frame playback rates. Further, the rate at which an individual consumer receives video media from the internet depends on a multitude of various factors including, among others, the individual consumer's local connection to the internet.

A personal computer (PC) provides one platform for viewing video media. The PC obtains the media, decodes the media, and renders the data for display on a display device. The PC utilizes software-based components alone or in combination with hardware components to decode and render the media. The PC platform's software-based configuration is versatile since it is adaptable to playing video of various formats with all kinds of video frame rates. As mentioned above such scenarios are, for instance, often encountered on the internet where a user may want to stream video from various web-sites which may utilize various different video formats and/or frame rates.

Other platforms, such as hardware-based platforms, are less versatile and have not succeeded in these types of applications. For example, if the consumer is surfing the web and clicks on media that is in a new format for which the PC is not configured, the PC may either automatically and/or by interfacing with the consumer, take appropriate actions to handle the new format. Hardware-based platforms are ‘configured’ upon manufacture and have no such capabilities.

This versatility of the PC has led to great consumer acceptance. However, to leverage its versatility, the PC platform has given priority to various design parameters over others. For example, because of the variability in the actual rate that the PC may receive media from a particular web-site at a particular instance, the PC may render individual frames of the media for display by the display device according to a best efforts scenario. For instance, the PC may schedule rendering of an individual frame based upon a presentation timestamp of the video frame and/or on the PC's ability to obtain and decode the data of an individual video frame.

The presentation timestamp is determined by the source of the data. The rendering process is not coordinated with the actual time that the display device will display the video frame. The lack of coordination with the display device and its supporting hardware means that some video frames may be displayed for the predetermined time of the display device, while other video frames may be displayed for longer or shorter periods of time. When one video frame is displayed a little bit early and longer and the next video frame is displayed a little bit later and shorter to compensate for the previous one, this is known as video rendering jittering. Jittering can result in a less pleasing user experience when compared to scenarios where each frame is presented for the same amount of time.

The tradeoffs between flexibility and video quality were accepted in the paradigm where PCs were generally used for rendering video from the internet. As technology progresses, consumers desire the flexibility offered by the current PC's software-based platform combined with increased image quality to fill an ever expanding niche of consumer devices and scenarios.

### SUMMARY

Software-based video rendering is described. In one implementation, a computing device has a hardware system to scan a display cycle of video frames and a software-based rendering engine configured to monitor the display cycle. The software-based rendering engine renders a video frame based, at least in part, on the monitored display cycle.

### BRIEF DESCRIPTION OF THE DRAWINGS

FIG. 1 illustrates an exemplary system in which software-based video rendering can be implemented.

FIGS. 2-3 illustrate timelines and events associated with the software-based video rendering.

FIG. 4 illustrates exemplary systems, devices, and components in an operating environment in which software-based video rendering can be implemented.

FIGS. 5A-5B illustrate a flow diagram that shows an exemplary software-based video rendering process.

### DETAILED DESCRIPTION

Overview

The following description relates to software-based video rendering. To create video images for a user, a display device and associated graphics hardware generate a series of sequential images which the user perceives as ‘motion video’. The display device is configured according to a set of standards to conform to a very precise display cycle. For a consistent period of each display cycle, the display device generates an image from an available video frame. A software-based video rendering engine is configured to track this display cycle. The software-based video rendering engine can render individual video frames for the display device at a suitable point in the display cycle based upon this tracking. A user's perception or viewing experience of the motion video is enhanced when a series of individual frames are rendered in accordance with the display device's display cycle.

For purposes of explanation, the examples described below are provided in the context of rendering video frames for a display device configured for use in the United States. TVs configured for use in the U.S. must conform to standards established by the National Television Standards Committee (NTSC). It is noted that the technology described herein is equally applicable to other device configurations, such as TVs configured for use in Europe that employ phase alternating line (PAL) standards.

The implementations detailed below are described in the context of a computing environment. Various implementations can be implemented by computer-executable instructions or code means, such as program modules, that are executed by a computer, such as a personal computer or PC. Generally, program modules include routines, programs, objects, components, data structures and the like that perform particular tasks or implement particular abstract data types.

Various implementations may be implemented in computer system configurations other than a PC. For example, various implementations may be realized in hand-held devices, multi-processor systems, microprocessor-based or programmable consumer electronics, network PCs, minicomputers, mainframe computers and the like. Further, as technology continues to evolve, various implementations may be realized on yet to be identified classes of devices. For example, the versatility of the present implementations combined with ever increasing processing power may produce devices resembling today's cell phones in general physical appearance, but which can perform various combined functionalities via the device's processing capabilities, data transmission capabilities and/or display capabilities. This is but one of many existing and developing applications for the described implementations.

Alternately or additionally, various implementations may also be practiced in distributed computing environments, where tasks are performed by remote processing devices that are linked through a communications network. In a distributed computing environment, program modules may be located in both local and remote memory storage devices.

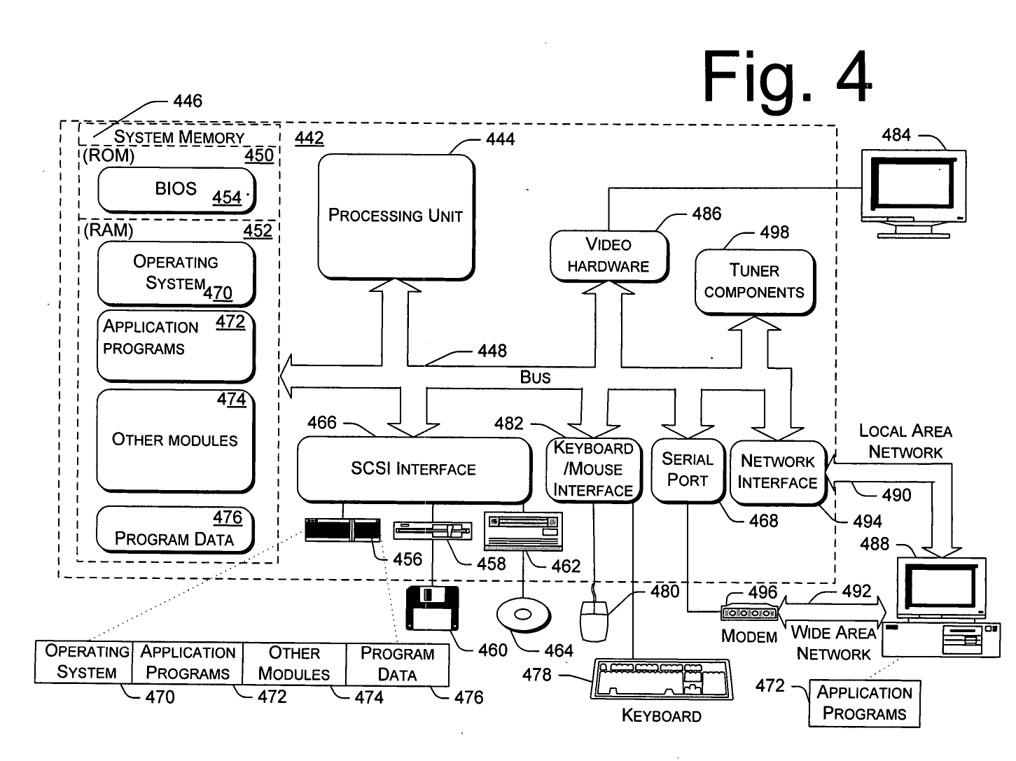

Although the various implementations may be incorporated into many types of operating environments as suggested above, a description of but one exemplary environment appears in FIG. 4 in the context of an exemplary general-purpose computing device in the form of a conventional computing device which is described in more detail at the end of this document under the heading “Exemplary Operating Environment”.

Exemplary Implementations

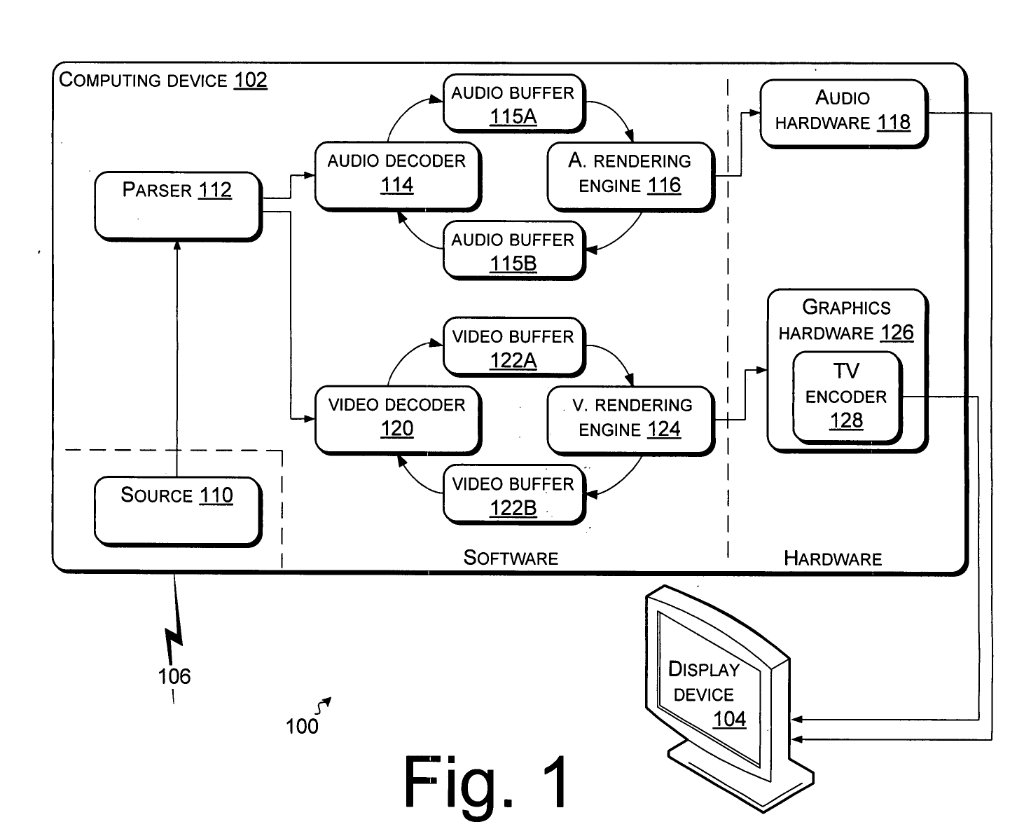

FIG. 1 illustrates an exemplary system 100 for performing software-based audio rendering and/or software-based video rendering. System 100 includes a computing device 102, such as a PC, coupled to a display device 104. Computing device 102 can also be coupled to a network, such as the internet, as indicated generally at 106.

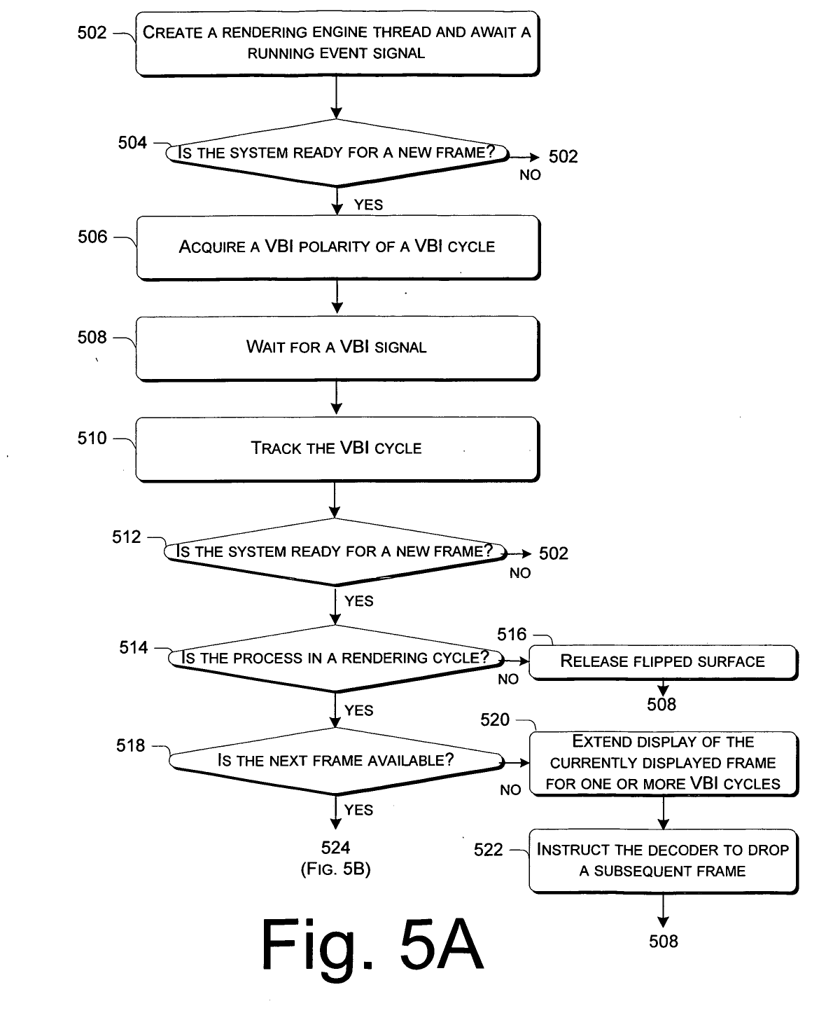

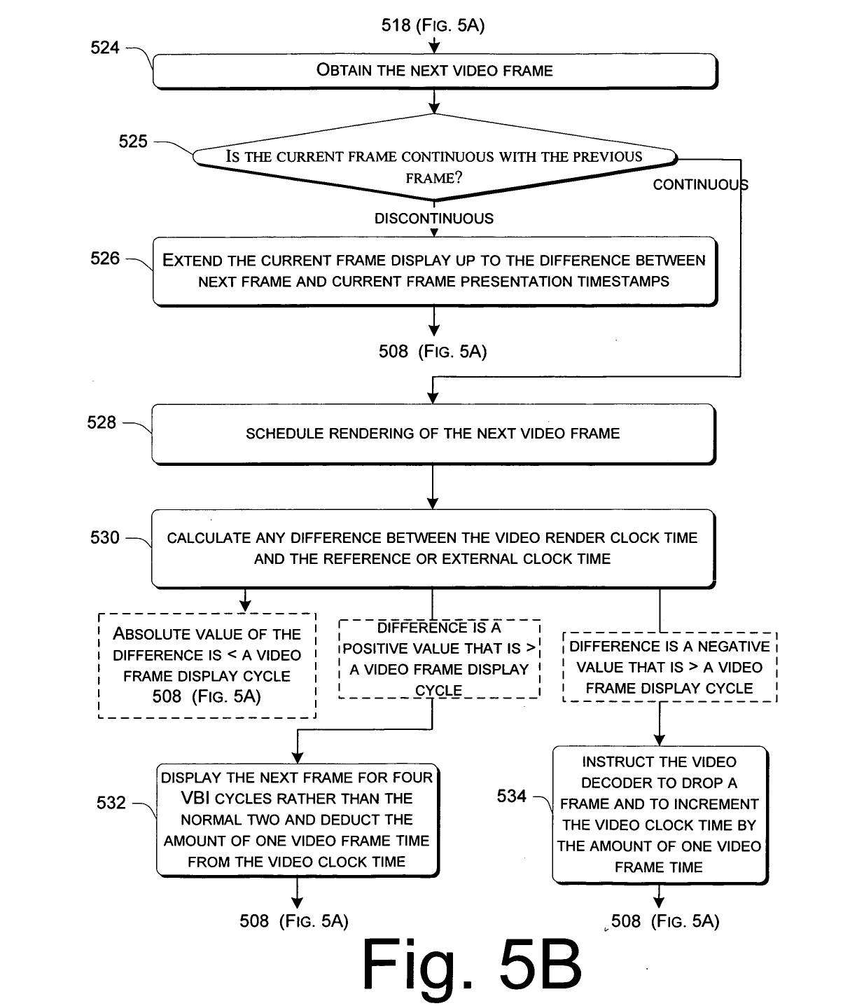

Computing device 102 can include a source 110, a parser 112, an audio decoder 114, two audio buffers 115A, 115B, a software-based audio rendering engine 116, and audio hardware 118. The computing device also includes a software-based video decoder 120, two video buffers 122A, 122B, a software-based video rendering engine 124, graphics hardware 126, and a TV encoder 128. In this particular system configuration, parser 112, audio decoder 114, audio buffers 115A, 115B, audio rendering engine 116, video decoder 120, buffers 122A, 122B, and video rendering engine 124 are implemented as software modules. These modules are stored in memory and executed by one or more processors. The memory and processor(s) are not explicitly illustrated in FIG. 1, but one exemplary configuration of such a computing system is shown in FIG. 5.

Source 110 represents a local store of video and/or audio content, where the content is stored in various formats. The source 110 may be implemented as a data storage or memory device. Alternatively or additionally to the source 110, the computing device 102 may also access an external source via network 106. Parser 112 is configured to recognize various data formats of the audio and/or video content received from source 110 or via network 106. The parser 112 distributes audio data to the software-based audio decoder 114 and video data to software-based video decoder 120.

Software-based video decoder 120 receives the video content from the parser 112 and decodes individual frames of the video content. The software-based video decoder 120 buffers decoded frames in buffer 122A. Software-based video rendering engine 124 accesses buffer 122A and renders the decoded frames placed in buffer 122A by video decoder 120. Once a frame is rendered, the software-based video rendering engine outputs the rendered frame to graphics hardware 126. The rendered frame is also stored in buffer 122B, where it can be used by the video decoder 120 for decoding of downstream frames. In this particular system configuration, two buffers are employed. However, in other system configurations, more that two buffers may be used. Further, this particular system configuration utilizes two FIFO (first in, first out) buffers.

Buffers 122A, 122B allow software-based video rendering engine 124 to operate independently and asynchronously from software-based video decoder 120. The video decoder 120 can process and queue video frames at one rate, while the video rendering engine 124 extracts and processes the frames at a different rate. This allows the video decoder 120 to decode video frames at a rate which is faster than the video frame display rate. So, for example, if the display rate is 30 frames per second (fps), the decoder may decode 40 fps for a period of time. By allowing the decoder to accumulate buffer frames, this implementation can perform satisfactorily in instances where the software-based video decoder may not get enough CPU cycles to decode a video frame on time, due to a sudden surge of other software modules having higher priority activities. The extra buffered frames can reduce this occurrence by allowing software-based video decoder 120 to decode a few more video frames ahead of time to compensate for such a situation.

Software-based video rendering engine 124 renders individual video frames to the graphics hardware 126. The graphics hardware presents the rendered frame to TV encoder 128. The TV encoder scans the video frame and presents the data in a form utilized by the display device 104 for generating the image. A sequential series of images creates user-perceptible motion video.

In compliance with NTSC standards, the display device 104 and the TV encoder 128 follow a defined display cycle to display each frame for two scanning or VBI cycles. Within a display cycle, the first scanning cycle relates to an even field and the second scanning cycle relates to an odd field. Each scanning cycle lasts for a duration of time specified by the standards. In the first scanning cycle, an image is created from the even field of the frame and in the second cycle, an image is created from the odd field which is interlaced with the even field. In the even field, TV encoder 128 scans the even lines of the frame and in the odd field, the TV encoder 128 scans the odd lines of the frame.

For every field, TV encoder 128 scans the lines starting at the top left of the screen and scans horizontally across every other line in turn until it reaches the bottom right of the screen. Upon reaching the bottom right, the TV encoder 128 goes through a non-scanning vertical blanking interval (VBI) event as it returns from the bottom right corner of the display to the top left. Each field is displayed for one scanning or VBI cycle where a VBI cycle is defined as spanning from one VBI event to the next VBI event. According to NTSC standards, each VBI cycle lasts 16.67 milliseconds (ms). Since each frame is displayed for two VBI cycles, the frame's display cycle is 33.34 ms.

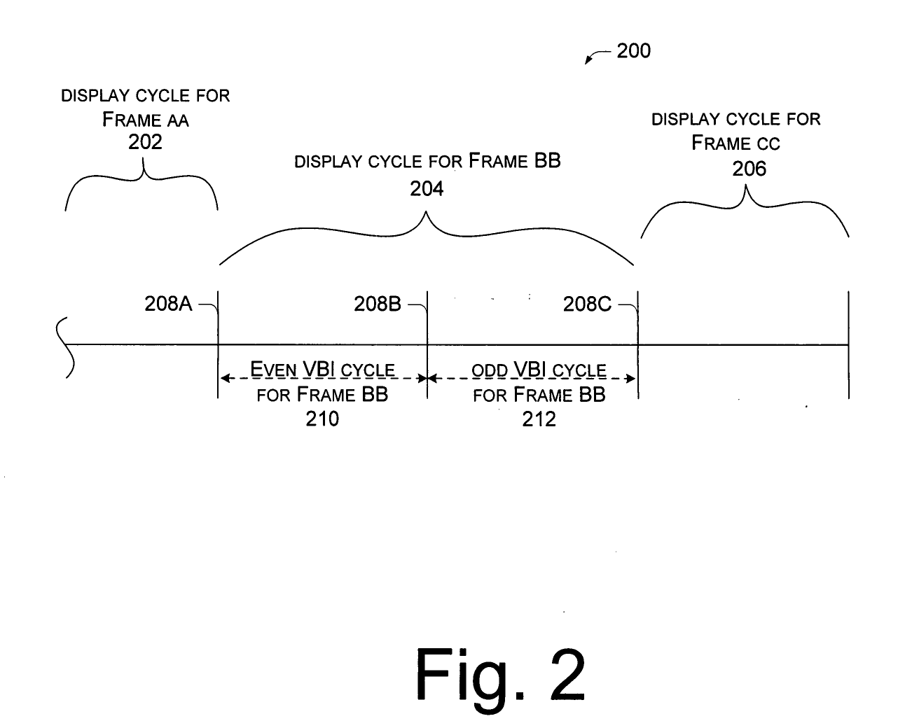

For purposes of explaining display cycles, consider FIGS. 1 and 2 collectively. FIG. 2 represents a timeline 200 of display cycles of three consecutive video frames AA, BB, and CC that are tracked by the software-based video rendering engine 124 generally at 202, 204, and 206, respectively. In timeline 200, time progresses from left to right. As depicted at the left-most region of timeline 200, a display cycle of current frame AA is indicated generally at 202. As mentioned above, a display cycle comprises two scanning or VBI cycles; an even field is scanned in the first VBI cycle and then an odd field is scanned in the second VBI cycle. Each VBI cycle culminates in a VBI event which does not contribute to image generation.

VBI event 208A demarcates the end of display cycle 202 and the beginning of display cycle 204 of frame BB. Display cycle 204 includes a first or even VBI cycle 210 and a second or odd VBI cycle 212. In order for display cycle 204 to properly display an image from frame BB, the frame should be available for graphics hardware to render just before VBI event 208A.

The rendering process is sometimes referred to as surface flipping or flip-flopping where the new frame BB is flipped from a back buffer surface to a front buffer surface for access by the graphics hardware while the current frame AA is correspondingly flipped from the front to the back.

The display cycle 204 of frame BB consists of even VBI cycle 210 which culminates in VBI event 208B and odd VBI cycle 212 which culminates in VBI event 208C. In response to VBI event 208B, subsequent frame CC is rendered so that it can be scanned in display cycle 206, only the even VBI cycle of which is represented in FIG. 2.

In compliance with the standards, TV encoder 128 adheres to a defined scanning cycle or VBI cycle of 16.67 ms. The TV encoder does not intentionally deviate from this cycle or take into account the operation of other system components. For example, the TV encoder does not have any discretion to shorten or lengthen individual VBI cycles. Each display cycle comprises two VBI cycles or 33.34 ms. The VBI cycles of the graphics hardware 126 and the TV encoder 128 are maintained in relation to either a TV encoder clock or a graphics clock (not specifically designated) of the graphics hardware.

Software-based rendering engine 124 can include a software-based rendering clock (not specifically designated). By monitoring the display cycles of the TV encoder 128 and/or the graphics hardware 126, the rendering clock of the rendering engine 124 can schedule events relative to the display cycle of the TV encoder. One example of a process for monitoring the display cycle is described below with relation to FIGS. 5A-5B.

As shown in FIG. 1, software-based video rendering engine 124 receives video frames from a source which may be internal or external to computing device 102. The video frames can include presentation times or time stamps established by an external clock or reference clock, such as a source clock. External clocks, which create timestamps, are not aware of the display cycle of the TV encoder or even of the graphic hardware's clock. The software-based video rendering engine 124 monitors the display cycle of the graphics hardware 126 to predict the actual time that the frame can be displayed relative to the graphic hardware's display cycle. The video rendering engine 124 then determines when to render the video frame to the video hardware based on this prediction. Further, while the software-based video rendering engine can schedule rendering upon the prediction the software-based video rendering engine continues to monitor the display cycle to ensure that the video frame is rendered at the appropriate time.

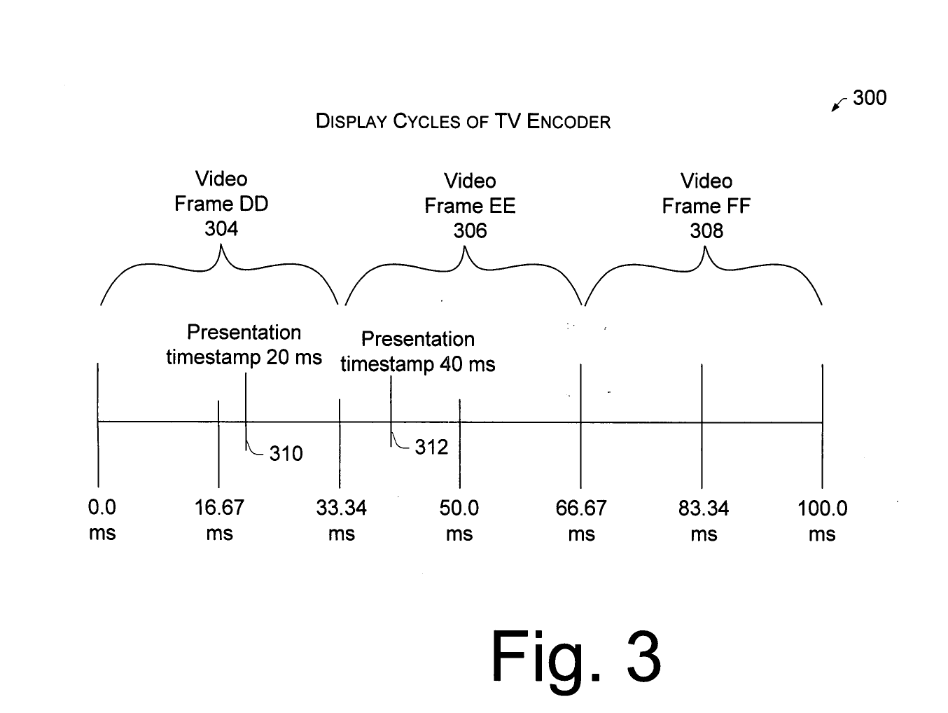

FIG. 3 illustrates one example where the rendering engine 124 determines an actual presentation time of individual video frames. A timeline 300 is depicted for a time duration of 100 ms. The timeline is demarcated in increments of 16.67 ms associated with a single VBI cycle. A consecutive set of two VBI cycles (or 33.34 ms) defines a display cycle, and three display cycles 304, 306, and 308 are shown in this example. The first display cycle 304 displays a video frame DD. The second display cycle 306 displays a second video frame EE and third display cycle 308 displays a third video frame FF.

Video frame EE has a presentation timestamp 310 of 20 milliseconds. Assume for purposes of explanation that the clock which established the timestamp is synchronized with the display cycle. From monitoring the TV encoder's display cycle, the software-based rendering engine 124 knows that video frame DD is being scanned from 0.0 ms until 33.34 ms and as such the actual presentation of video frame EE cannot be begin until after this time. As such, the software-based rendering engine knows that the actual presentation time of video frame EE should be the next display cycle 306 which starts at 33.35 ms and runs to 66.67 ms.

Similarly, video frame FF has a presentation time 312 of 40 ms. The software-based rendering engine knows that the next available display cycle 308 starts at 66.68 ms so the actual presentation time will begin then. The rendering engine can schedule to render video frame FF in the second half of display cycle 306. The software-based rendering engine does not schedule to render frame FF in the first half of display cycle 306 even though it may be closer to the timestamp presentation time 312 since undesirable results may be produced. Such undesirable results are described in more detail below in relation to FIGS. 5A-5B.

FIG. 3 illustrates how the software-based video rendering engine can determine actual presentation times for individual video frames and render them accordingly. Various system configurations may have some degree of latency on the rendering side and/or on the graphics hardware side. This latency can be factored in by some implementations to calculate even more accurate actual presentation times and/or to schedule rendering times. The software-based video rendering engine may also communicate the actual rendering time of an individual video frame to audio decoder 114 and/or audio rendering engine 116 so that audio rendering times may be adjusted accordingly.

As described above, the software-based video rendering engine can monitor the display cycle to determine rendering and/or presentation times of individual video frames if so desired. The software-based video rendering engine need not rely on these predetermined values as it continues to get real-time signals, such as the VBI signals, from the display cycle right up until it renders a video frame. Some implementations can ultimately render a video frame based upon the real-time signals rather than predetermined times.

By rendering video frames in accordance with the display cycle of the video hardware, a user-experience of the resultant motion video can be enhanced. Exemplary processes for monitoring the display cycle to determine when to render video frames is described below in relation to FIGS. 5A-5B.

Exemplary Operating Environment

FIG. 4 shows an exemplary computing device that can be used to implement the software-based video rendering process described above. Computing device 442 comprises one or more processors or processing units 444, a system memory 446, and a bus 448 that couples various system components including the system memory 446 to processors 444. Threading techniques can be employed on the one or more processors to allow parallel processing of multiple tasks by multiple processing threads.

The bus 448 represents one or more of any of several types of bus structures, including a memory bus or memory controller, a peripheral bus, an accelerated graphics port, and a processor or local bus using any of a variety of bus architectures. The system memory 446 comprises read only memory (ROM) 450 and random access memory (RAM) 452. A basic input/output system (BIOS) 454, containing the basic routines that help to transfer information between elements within computing device 442, such as during start-up, is stored in ROM 450.

Computing device 442 can further comprise a hard disk drive 456 for reading from and writing to a hard disk (not shown), a magnetic disk drive 458 for reading from and writing to a removable magnetic disk 460, and an optical disk drive 462 for reading from or writing to a removable optical disk 464 such as a CD ROM or other optical media. The hard disk drive 456, magnetic disk drive 458, and optical disk drive 462 are connected to the bus 448 by an SCSI interface 466 or some other appropriate interface. The drives and their associated computer-readable media provide nonvolatile storage of computer-readable instructions, data structures, program modules and other data for computer 442. Although the exemplary environment described herein employs a hard disk, a removable magnetic disk 460 and a removable optical disk 464, it should be appreciated by those skilled in the art that other types of computer-readable media which can store data that is accessible by a computer, such as magnetic cassettes, flash memory cards, digital video disks, random access memories (RAMs), read only memories (ROMs), and the like, may also be used in the exemplary operating environment.

A number of program modules may be stored on the hard disk 456, magnetic disk 460, optical disk 464, ROM 450, or RAM 452, including an operating system 470, one or more application programs 472 (such as a user agent or browser), other program modules 474, and program data 476. A user may enter commands and information into computer 442 through input devices such as a keyboard 478 and a pointing device 480. Other input devices (not shown) may comprise a microphone, joystick, game pad, satellite dish, scanner, or the like. These and other input devices are connected to the processing unit 444 through an interface 482 that is coupled to the bus 448. A monitor 484 or other type of display device is also connected to the bus 448 via an interface, such as video hardware 486. In addition to the monitor, personal computers typically comprise other peripheral output devices (not shown) such as speakers and printers.

Computer 442 commonly operates in a networked environment using logical connections to one or more remote computers, such as a remote computer 488. The remote computer 488 may be another personal computer, a server, a router, a network PC, a peer device or other common network node, and typically comprises many or all of the elements described above relative to computer 442. The logical connections depicted in FIG. 4 comprise a local area network (LAN) 490 and a wide area network (WAN) 492. Such networking environments are commonplace in offices, enterprise-wide computer networks, intranets, and the Internet.

When used in a LAN networking environment, computer 442 is connected to the local network through a network interface or adapter 494. When used in a WAN networking environment, computer 442 typically comprises a modem 496 or other means for establishing communications over the wide area network 492, such as the Internet. The modem 496, which may be internal or external, is connected to the bus 448 via a serial port interface 468. In a networked environment, program modules depicted relative to the personal computer 442, or portions thereof, may be stored in the remote memory storage device. It will be appreciated that the network connections shown are exemplary and other means of establishing a communications link between the computers may be used.

The computer could also contain analog or digital tuner components 498. The tuner components can be linked to the system either through an internal or extended bus such as PCI or external bus such as USB bus, IEEE-1394 bus. The tuner components allow the system to receive broadcasting TV through standard TV broadcasting media such as terrestrial, cable, and satellite.

Generally, the data processors of computer 442 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The system described herein comprises these and other various types of computer-readable storage media when such media contain instructions or programs for implementing the blocks described, in conjunction with a microprocessor or other data processor. The system described can also comprise the computer itself when programmed according to the methods and techniques described herein.

For purposes of illustration, programs and other executable program components such as the operating system are illustrated herein as discrete blocks, although it is recognized that such programs and components reside at various times in different storage components of the computer, and are executed by the data processor(s) of the computer.

Exemplary Processes

FIGS. 5A-5B represent a software-based process for rendering video data. This particular implementation is based upon standards established by the national television standards committee (NTSC) which is utilized in the United States among other countries. The concepts described below are applicable to other standards such as phase alternating line (PAL) which is utilized in Europe, digital versatile disk (DVD) and 480p, among others. In but one configuration, the process can be implemented using a system such as the ones described in relation to FIGS. 1 and 4. The described software-based video rendering process includes acts 502-534. Acts 502-524 generally relate to the video rendering process, while acts 526-534 generally relate to addressing potential clock drift between an external clock and a rendering process clock. The software-based video rendering process begins with a start-up process at act 502.

At act 502, the software-based video rendering process creates a video rendering engine thread in response to a media player application being opened by a user. The process then awaits a running event signal such as a play command from a user. The graphics hardware generates an interrupt signal when a particular interrupt line is encountered during VBI cycling. The interrupt signal interrupts the CPU. In response, the CPU notes the occurrence of the interrupt signal and the interrupt line which generated it. The CPU delivers the interrupt signal to a driver interrupt handler. The CPU examines a waiting thread queue and if the CPU identifies a thread which is waiting for the interrupt signal the CPU moves the identified thread from the waiting thread queue to a ready thread queue. In this instance, the rendering engine thread is waiting on the interrupt signal and is moved to the ready thread queue. The CPU will then examine the priority of the video rendering engine thread against any currently running thread and if the video rendering engine thread has priority the CPU will run the video rendering engine thread and move the current thread to the ready queue. The process then awaits arrival of a first video sample or frame from the video decoding process.

At act 504, upon arrival of a video frame at a buffer available to the software-based video rendering process, the process queries whether the system is ready for a new frame. This act allows the process to check a running state of the system to ensure that the video frame is in fact desired. This act reduces the chance that processing power and/or other resources will be wasted. For instance, a user may have pressed ‘play’ but by the time the process reached this point, the user may have pressed ‘pause’ or the user may have changed channels thereby eliminating the need to render the video frame. In this example, if the user pressed pause then the system is not ready for a new frame. If the video frame is not desired, then the process returns to act 502.

If the video frame is desired, the software-based video rendering process acquires a VBI polarity of a VBI cycle (act 506). VBI cycles occur on the hardware subsystem which operates in cooperation with a display device to create an image from a given video frame. Each video frame is displayed for a display cycle, which consists of two VBI cycles. The first or even VBI cycle scans the even field of the video frame. The second or odd VBI cycle scans the odd field of the video frame. By acquiring the VBI polarity, the process knows whether the display cycle of an individual frame is in the first VBI cycle or the second VBI cycle. Examples of display cycles and VBI cycles are described above in relation to FIGS. 2-3.

Suppose, for explanation purposes, the process acquires the odd VBI polarity. By acquiring the odd VBI polarity, the process knows that the second field of the current frame is being scanned by the TV encoder 128.

At act 508, the software-based video rendering process waits for the next VBI signal. As described above, a VBI event occurs at the end of a VBI cycle and indicates the start of a vertical blanking phase of the VBI cycle. The graphics hardware creates a VBI signal at each VBI event and this VBI signal is detected by the software-based video rendering engine. Receiving a VBI signal at the end of scanning the even field indicates that the next VBI cycle will have an odd polarity. Similarly, receiving a VBI signal after the odd field is scanned indicates that the next VBI cycle will have an even polarity. Accordingly, upon receipt of the VBI signal separating the even VBI cycle from the odd VBI cycle indicates that the display cycle of the current frame will be complete just before next VBI signal. By acquiring the VBI polarity and waiting for the VBI signal, the software-based video rendering process can schedule to render the next frame in the approaching odd VBI cycle.

At act 510, the software-based video rendering process tracks the VBI cycle. By tracking the VBI cycle, the process need not re-ascertain the VBI polarity which may take more time than a single VBI cycle to acquire. By acquiring the VBI polarity initially and than tracking the VBI cycle, the software-based video rendering engine knows the points of each display cycle relative to the video rendering engine's video rendering clock. Among other advantages, this feature can allow the software-based video rendering engine to avoid the possibility of rendering a new frame when only the even cycle of the current frame had been scanned. Lacking such a technique, some existing processes can lead to a scenario where a new frame is scheduled to be rendered during the even field VBI cycle causing the second or odd cycle of the current frame to be omitted with the new frame scanned in its place. Such a scenario can lead to a less pleasing user experience. In such an instance, the new frame may be scanned in a reverse temporal order. For example, odd field then even field, rather than even field then odd field, which can further decrease user satisfaction.

Further, by tracking the VBI cycle, the software-based video rendering engine can update the video rendering clock accordingly, since each VBI cycle takes exactly 16.67 ms, based on the graphics clock. So for instance, each time a VBI signal is detected, the video rendering clock can be moved up accordingly. This allows the rendering process to more accurately time its activities with the display cycle. For example, there may be other tasks that the software rendering engine completes in certain VBI cycles.

Alternatively or additionally, clock drift between the graphics clock and the reference clock can also be deduced by updating the video rendering clock upon detection of each VBI event and comparing the video rendering clock with the time of the reference clock.

As will be discussed in more detail below, the clock synchronization process of act 510 can allow the software-based video rendering process to be slaved to a live video source clock from a standard TV broadcasting media such as terrestrial, cable, and satellite sources.

Also, as will be discussed in more detail below, keeping an accurate video render clock allows the software-based video rendering process to synchronize other components and/or presentations. For example, the software-based video rendering process may determine the actual time that an image will be generated from a given video frame.

The software-based video rendering process may then utilize the actual presentation time to reduce audio visual disparity. For example, the software-based video rendering process may communicate the actual display time of a video frame to the audio decoder and/or audio rendering engine so that the audio and visual aspects can be synchronized.

For example, upon receiving the VBI signal at the start of the odd field of the current frame, the software-based video rendering process knows that it will render the next frame upon receiving the next VBI signal in about 16.67 ms. The software-based video rendering process also knows that scanning of the next frame will commence at that point in time. As such, the software-based video rendering process may direct the audio rendering engine to render the associated audio packets 16.67 ms later. Such a synchronization process can produce audio video synchronization within a definite upper limit that is far below human perception.

At act 512, the software-based video rendering process once again checks whether the system is ready for a new frame. This step checks the running state of the system to ensure that resources are not wasted on unneeded rendering. If the system is not ready for the next frame (i.e., the “No” branch), the process waits until the system is ready. Once the system is ready (i.e., the “Yes” branch), it is determined whether the software-based video rendering process is in a rendering cycle (act 514). For example, the software-based video rendering process may check to see if it is scheduled to render a frame in the next 33.34 ms or not. One example of such scheduling is described above in relation to FIG. 3.

This act, among other attributes, can allow for improved resource allocation. If the software-based video rendering process foresees the desire to reserve a certain amount of resources, most notably the graphics hardware resource, in a video rendering cycle then the software-based video rendering process keeps resources which are reserved for it. If the software-based video rendering process completes the video rendering in a given rendering cycle, then the software-based video rendering process may let other processes utilize some of its reserved processing resources. By tracking the display cycle and/or the VBI cycle, there may be times when processing resources which are reserved for the software-based video rendering process can be reallocated to other processing tasks. Tracking the VBI cycle and updating the video rendering clock allow the software-based video rendering process to know when the resources should be reserved for the software-based video rendering process and when they are available for other processing tasks.

For example, assume that the software-based video rendering process needs a specific graphics hardware unit to perform specific operation tasks before the software-based video rendering process can schedule a surface flip in a rendering VBI cycle. Surface flipping is described above in relation to FIG. 2. Further, assume that other modules, such as a user interface (UI) module, use the same graphics hardware unit. The software-based video rendering process gives priority to the rendering process so that the rendering process can complete its tasks on time. Other components, such as the UI module may be allowed to utilize processing resources once the rendering process has completed its scheduled tasks.

One technique for ensuring that the software-based video rendering process is able to timely achieve its processing tasks is to allow the software-based video rendering process to grant or deny access to the graphics unit to other software modules desiring to issue any tasks to the graphics unit. For instance, the software-based video rendering process may measure the percentage of the graphics unit's resources that the software-based video rendering process should reserve. In an extreme case, if the software-based video rendering process needs 100% of the graphics unit's resources, then the software-based video rendering process can determine the latest time span that the software-based video rendering process should have 100% of the graphics unit's resources to succeed in scheduling a surface flip before the rendering VBI cycle expires. Hence, the software-based video rendering process can limit or gate other software modules' usage of the graphics unit accordingly. For example, the software-based video rendering process can turn on the resource gate just after the software-based video rendering process schedules the surface flip, but only allow the UI module to use a certain percentage of the graphics unit up to a certain time in the future. Then the software-based video rendering process turns off the resource gate to the other software modules such that all tasks scheduled will be completed before a certain time into the rendering VBI cycle so that the tasks that the software-based video rendering process may schedule will be completed with enough safety margin to allow the software-based video rendering process to schedule the surface flip, before the rendering VBI cycle expires.

If the software-based video rendering process is not in a rendering cycle, then the process proceeds to act 516. If the process is in a rendering cycle then the process proceeds to act 518.

At act 516, the software-based video rendering process releases the flipped surface, i.e. the previously scanned frame. Note, that as discussed earlier, the memory buffer attached to the back surface has been swapped with that of front surface. Therefore the process can release the present back surface along with its attached buffer to the buffer queue. The video decoder can acquire the released buffer in order to fill the buffer with a newly decoded video frame in the order of the presentation timestamps. Such a buffer is designated as video buffer 122B in FIG. 1. At this point the process proceeds to act 508.

At act 518, where the software-based video rendering process is in a rendering VBI cycle, the process checks whether the next frame is available. In some configurations, the next video frame should be available to the software-based video rendering process to acquire and consume from the buffer FIFO queue such as from buffer 122A described in relation to FIG. 1. This particular FIFO buffer queue is filled by the software-based video decoding process in chronological order according to the frame presentation timestamps. In one scenario, the software-based video decoding process has decoded one or more frame(s) and has filled them to the buffer(s) acquired from video buffer 122B as described in relation to FIG. 1 and placed the video frames into video buffer 122A of FIG. 1 for receipt by the software-based video rendering engine. In another scenario, glitches may prevent the software-based video decoding process from delivering the next video frame in time. If this latter situation occurs and the next video frame is not available during the VBI rendering cycle, then the software-based video rendering process proceeds to act 520. If the next frame is available, the software-based video rendering process takes it out of the queue and proceeds to act 524.

At act 520, since the software-based decoding process does not deliver the video frame in time, the software-based video rendering process extends the display of the currently displayed video frame for one or more VBI cycles. One approach is to extend the current frame for another two VBI cycles or about 34 ms. The process then proceeds to act 522.

At act 522, in order to allow the software-based video decoding process to make up the loss and to allow the decoding process to catch up, the software-based video rendering process instructs the decoding process to drop a subsequent video frame.

Processing resources may be saved by allowing the software-based video decoding process to select the subsequent frame to drop to compensate for a late frame. For example, assuming a compressed video stream contains reference frames and non-reference frames. The software-based video decoding process must decode all the reference frames, which will be used to decode other frames. Therefore, the decoding process can choose not to decode a non-reference frame. Typically, non-reference frame takes several times more system resources to decode. One or more non-reference frames are usually present in between two reference frames. Hence by not decoding a non-reference frame, the software-based video decoding process can catch up in no more than two frame times. For instance, if the next frame to be decoded is a non-reference frame, then the video decoder can drop that frame. If the next frame is a reference frame, then the following frame should be a non-reference frame and the video decoder can drop that frame. This allows the presentation timestamp of a displayed video frame to deviate from that of the corresponding rendered audio samples by 34 ms or less for two display cycles or less and then the audio and video may be resynchronized.

As a concrete example, a main profile of standard based video compression such as MPEG-2/4/10 or WMV9 video contains B (bi-directional predicated) frames, which are not necessary to decode since a B frame is not used as a reference frame for constructing other frames. A B frame also takes more system resources to decode when compared with other frame types. Therefore, the software-based video decoding process could choose not to decode the first B frame it encounters after it receives the drop frame command of act 522.

An alternative approach, not shown in FIG. 5A, is to extend the current frame for displaying just one more VBI cycle and to designate the next VBI cycle as a rendering cycle. If the new video frame is available in the next VBI cycle, the new frame is displayed for just one VBI cycle. This scheme may be limited to once per incidence of act 520 within the next 4 VBI cycles. After the single incidence, the current frame can be display for another two VBI cycles as described at act 520 to allow the video decoding process to catch up.

In an alternative scenario for act 522, if the software-based video rendering process receives the next video frame after the scheduled render time such that the next display cycle has started again on the current frame, then the software-based video rendering process determines if the display cycle is in the first half of the display cycle. If the next video frame is received in the first half of the display cycle, i.e. during the first or even VBI cycle then the process renders the late arriving frame and proceeds to act 530 as if the video frame was rendered on time. This process step allows a frame which is late arriving from the decoder to be displayed for the last half of its display cycle. In the instance where act 522 instructs the video decoder to drop a frame, then the software-based video rendering process proceeds to act 508.

At act 524, the software-based video rendering process obtains the next video frame.

At act 525, the software-based video rendering process checks whether the next video frame is continuous with the previous frame. The software-based video rendering process checks the continuity of the presentation timestamp of the video frame obtained by act 524 with regard to the proceeding frame's presentation timestamp. This check excludes any discontinuity caused by act 522. If a discontinuity exists, the software-based video rendering process proceeds to act 526. If the frames are continuous, the software-based video rendering process proceeds to act 528.

At act 526, since a discontinuity exists, the software-based video rendering process extends the current frame display time up to the difference between the previous frame's presentation timestamp and the next frame's presentation timestamp.

One example that can cause such a discontinuity between the next frame and the preceding frame can occur in the context of playing a DVD, such as a DVD movie, with the software-based video rendering process. In such an example, a DVD menu may be displayed for the user within the video stream of the movie. In one such scenario the menu is invoked and/or removed by a user command. For instance if a user selects to ‘pause’ playback, a frame representing the menu and indicating the pause condition may be inserted as a video frame in the video stream. As such, the DVD menu is not part of the video stream of the movie. Further, the video frames of the movie have timestamps inserted by the source. The menu may or may not include a time stamp. If the menu does have a timestamp it likely has little or no correlation to the timestamps of the movie frames. As such, each time a menu is inserted or removed from the video stream it creates a discontinuity. Note that the DVD menu can appear at anytime if invoked by a user. Further, it is also difficult to decide exactly how long one still frame is displayed since a user could make a selection at any time. If the user resumes the previous play condition, the menu frame may then be removed creating another discontinuity in the video stream. After extending the display time of the next frame, the software-based video rendering process then returns to act 508.

At act 528, the software-based video rendering process schedules rendering of the next video frame. The act of rendering the next frame can be accomplished by flipping the surface containing the next frame buffer.

The software-based video rendering process steps described above monitor the display cycle via process steps 504-508. The software-based video rendering process then renders the next frame, if available, upon receiving a real-time VBI signal generated at the culmination of scanning the odd field of the current frame. The rendering process need not be this precise. Other exemplary processes may monitor the display cycle and render the next frame anytime after the display cycle of the current frame is more than one half completed. As described above in relation to FIG. 2, once the fields of the current frame are flipped for scanning, the next frame can be rendered and the video hardware will not scan it until the next display cycle. So, for example, some software-based video rendering processes may render the next frame as soon as the software-based video rendering process ascertains that the downstream components are starting the second half of the current display cycle.

After act 528, the software-based video rendering process proceeds to a clock synchronization sub-routine, starting at act 530 before returning to act 508, to repeat the rendering process. At act 530, the software-based video rendering process calculates any difference between the video render clock time and the reference clock. Comparing the reference clock and the video render clock is described above in relation to act 510. If the absolute value of the difference between the video render clock time and the reference clock time is less than the frame display cycle duration, then the software-based video rendering process proceeds to act 508.

If the difference between the video render clock time and the reference clock time is a positive value that is greater than a video frame display cycle, which indicates the video render clock or graphics hardware clock is faster than the reference clock, then the software-based video rendering process proceeds to act 532.

If the difference video between the video render clock time and the reference clock time is a negative value that is greater than a video frame display cycle, which indicates the video render clock or graphics hardware clock is slower than the reference clock, then the software-based video rendering process proceeds to act 534.

At act 532, the software-based video rendering process displays the next frame for four VBI cycles rather than the normal two VBI cycles. Stated another way, the software-based video rendering process doubles the display time of the next video frame by designating that the fourth VBI cycle as the next rendering VBI cycle rather than the second VBI cycle. The software-based video rendering process also deducts the amount of one video frame time from the video clock time. The software-based video rendering process then returns to act 508 to repeat the rendering process.

At act 534, the software-based video rendering process instructs the video decoder to drop a frame and to increment the video clock time by the amount of one video frame time. A very similar principle can be applied when the next frame is received any number of display cycles late. The software-based video rendering process then returns to act 508 to repeat the rendering process.

As a result of the video clock adjustment done in act 532 and/or act 534, the video clock drift time is brought back within one video frame time, or 33 ms of the reference clock and the software-based video rendering process can proceed back to act 508.

The above described process steps are applicable and/or can be adapted to video conforming to other standards beyond the NTSC. For example, for progressive standards, the software-based video rendering process does not use VBI polarity since this is only relevant to interlaced content.

Similarly, the software-based video rendering process is applicable to standards having other cycle durations. In some such implementations, the software-based video rendering process can do reverse telecine. Meaning for example, that the process can effectively achieve a 24 frames per second (fps) rate by rendering video frames as if the frame rate was 30 fps. The software-based video rendering process can then set every fourth frame flip interval to 4 rather than the standard 2, which means every forth frame will be displayed twice as long as the three preceding frames. These are but a few of the possible examples of applications for the software-based video rendering process described above.

Software-based video rendering is described above. In one implementation, a computing device has a hardware system to scan a display cycle of video frames and a software-based rendering engine configured to monitor the display cycle. The software-based rendering engine renders a video frame based, at least in part, on the monitored display cycle.

Although implementations relating to software-based video rendering have been described in language specific to structural features and/or methods, it is to be understood that the subject of the appended claims is not necessarily limited to the specific features or methods described. Rather, the specific features and methods are disclosed as exemplary implementations for software-based video rendering.

1. A computing device, comprising:
a hardware system to scan video frames according to a display cycle; and,
a software-based video rendering engine configured to monitor the display cycle to determine when to render a video frame.

2. A computing device as recited in claim 1, wherein the software-based video rendering engine is further configured to render the video frame when the display cycle reaches a predetermined point.

3. A computing device as recited in claim 2, wherein the software-based video rendering engine is further configured to determine a time at which the rendered video frame will enter the display cycle.

4. A computing device as recited in claim 3, wherein the software-based video rendering engine is further configured to communicate the time to a software-based audio renderer so that an audio presentation time of audio associated with the rendered frame can be synchronized with a presentation of the video frame.

5. A computing device as recited in claim 1, wherein the software-based video rendering engine is further configured to receive a signal from the hardware system indicating that the hardware system has reached a specific point in the display cycle.

6. A computing device as recited in claim 5, wherein the specific point comprises a vertical blanking interval (VBI) event.

7. A computing device as recited in claim 1, wherein the display cycle comprises two vertical blanking interval (VBI) cycles.

8. A computer-readable media comprising computer-executable instructions that, when executed, perform acts, comprising:
monitoring a display cycle of hardware components configured to scan video frames for display on a display device; and,
rendering a video frame based, at least in part, on the monitored display cycle.

9. A computer-readable media of claim 8, further comprising the acts of:
creating a rendering engine thread;
responsive to detecting an interrupt signal relevant to the rendering engine thread, moving the rendering engine thread from a waiting thread queue to a ready thread queue.

10. A computer-readable media of claim 8, wherein the act of monitoring comprises:
acquiring a polarity of the display cycle;
receiving a VBI signal; and,
tracking the display cycle using the VBI signal.

11. A computer-readable media of claim 8, wherein the act of rendering comprises:
responsive to receiving a VBI signal when the display cycle is in an odd polarity, rendering the video frame.

12. A computer-readable media of claim 8, wherein the display cycle comprises a first even field scanning cycle and a second odd field scanning cycle and further comprising determining when the display cycle has finished scanning the first even field.

13. A computer-readable media of claim 12, wherein the act of rendering comprises rendering the video frame responsive to the act of determining.

14. A computer-readable media of claim 8 further comprising based upon the act of monitoring, determining a time when the rendered frame will be displayed by the hardware components.

15. A computer-readable media of claim 14 further comprising communicating the time to a software-based audio rendering component such that the software-based audio rendering component can adjust a presentation time of corresponding audio content.

16. A computer-readable media of claim 8 further comprising comparing a clock of the hardware components to an external clock associated with timestamping the video frames, and in the event that the hardware clock is slower than the external clock by a display cycle or more, dropping a video frame that would otherwise be rendered, and in the event that the hardware clock is faster than the external clock by a display cycle or more, rendering a single video frame for two consecutive display cycles.

17. A computer-readable media of claim 16, wherein said dropping a video frame comprises instructing the video decoder to drop a subsequent frame that has not yet been decoded.

18. A computer-readable media of claim 16, wherein said dropping a video frame comprises instructing the video decoder to drop a subsequent frame that has not yet been decoded and allowing the video decoder to select an individual frame to drop.

19. A computer-readable media comprising computer-executable instructions that, when executed, perform acts, comprising:
predicting a time at which an individual video frame should be rendered based, at least in part, upon a display cycle of hardware configured to create an image from the video frame; and,
prior to rendering the video frame at the time, verifying the display cycle by receiving at least one real-time signal from the hardware indicating a specific point in the display cycle.

20. A computer-readable media of claim 19, wherein the one real-time signal comprises an odd VBI signal.
